(19) United States
(12) Patent Application Publication
(10) Pub. No.: US 2017/0238500 A1
(43) Pub. Date: Aug. 24, 2017

(54) BUTTERMAKING APPARATUS

(71) Applicant: GEA MECHANICAL EQUIPMENT GMBH, Oelde (DE)

(72) Inventors: Siegfried KLAPPER, Herzebrock-Clarholz (DE); Reinhard MOSS, Ennigerloh (DE)

(21) Appl. No.: 15/434,128

(22) Filed: Feb. 16, 2017

(30) Foreign Application Priority Data
Feb. 19, 2016 (DE) 20 2016 100 892.1

(51) Int. Cl. A01J 15/04; A23C 3/02; A01J 15/24

(52) U.S. Cl. CPC A01J 15/06

(57) ABSTRACT

A buttermaking apparatus includes an inlet, a churning cylinder having a rotatable beater, a secondary churning drum having a hood, at least one press stage having a press, and at least one inspection glass having a viewing window. The viewing window has a heater to melt butter accumulated on the viewing window.

### CROSS-REFERENCE TO RELATED APPLICATIONS

This application claims priority under 35 USC 119 to German Application 20 2016 100 892.1, filed Feb. 19, 2016, the entire disclosure of which is herein expressly incorporated by reference.

### BACKGROUND AND SUMMARY OF THE INVENTION

Exemplary embodiments of the invention are directed to a buttermaking apparatus.

Conventional industrial churning processes typically involved continuous churning with a buttermaking machine or apparatus according to Dr. Fritz from the year 1941. This machine and the corresponding process provide a good and uniform butter quality, combined with low fat losses.

The development of the Fritz-Eisenreich process allowed automation of the work steps comprising the whipped cream formation, the subsequent butter grain formation, the separation of buttermilk, and the kneading of the butter. In this context, churning drums ensured the processes of butter grain formation, and motorized worm drives were employed for the kneading of the acquired butter intermediate product by presses.

German patent document DE 10 2009 044 429 A1 discloses an exemplary buttermaking apparatus.

In such apparatus visual monitoring of the process flow is achieved using inspection glasses in the region of a secondary churning drum and/or in the region of a vacuuming device in a press. Due to the visual monitoring of the process flow, process parameters of the buttermaking, such as, for example, the rotation speed of a so-called beater, or settings on the press, are altered during the process flow according to requirement.

Processes and apparatuses of this type have proved successful in practice. In such apparatuses, however, impairments to the ability to observe the process flow result from the depositing of butter on the inspection glasses.

As a result of the butter deposits on the inspection glasses, a visual monitoring of the process flow of buttermaking is possible only to a very restricted extent, or even is no longer possible at all.

Exemplary embodiments of the present invention are directed to improving the observability of buttermaking with a buttermaking apparatus.

According to an exemplary embodiment, a buttermaking apparatus includes an inlet, a churning cylinder having a rotatable beater, a secondary churning drum having a hood, a press stage, at least one inspection glass having a viewing window, wherein the viewing window has a heating device, i.e., a heater. The heating device advantageously allows butter deposits adhering to the viewing window of the inspection glass to be melted, so that they can drip down from the inspection glass, and thus the observability of the churning process is thereby improved.

In a preferred embodiment of the invention, the heating device is based on an electrical working principle. As a result, the heating device can be easily and advantageously integrated into the viewing window of the respective inspection glass.

In a further preferred embodiment, at least the viewing window of the heatable inspection glass, as a supplement to the cleaning, can be subjected to a fluid. As a result, butter deposits on the viewing window that have been melted by the heating element can thereby advantageously additionally be rinsed off the viewing window. Hence films on the viewing window that are formed in addition to the butter deposits and derive from butter additives, such as, for example, additional flavoring substances, water or whey, acid concentrates and brine, can advantageously also reliably be automatically cleaned off.

Steam is advantageously used as the fluid, wherein the accruing condensate is collectable by devices on the inspection glasses or is extractable/can be sucked off with a pump, and in this way is wholly or partially retrievable from the churning process.

In a further embodiment of the invention, the fluid is conducted through one or more nozzle-like passages onto the viewing window of at least one inspection glass. A simple and effective, and thus advantageous, application of the fluid to the viewing window is thereby provided.

It is advantageous if an intermediate element has the one or more nozzle-like passage(s). The fluid can thereby be conducted purposefully, and thus advantageously, onto the viewing window of the inspection glass.

In a further design variant of the invention, the one or more nozzle-like passages is/are arranged preferably at an angle β of 10 to 20°, particularly preferably 15°, perpendicular to an axis of an opening of the intermediate element. As a result of the advantageous angular position of the nozzle-like passages, a secure, and thus advantageous cleaning of the viewing window of the inspection glass is realizable.

According to a further embodiment of the invention, the plurality of nozzle-like passages are arranged in a parallel plane perpendicular to the axis of the opening, to be precise preferably at an angle a of 20 to 60°, particularly preferably of 30°, to one another (in a fan-like arrangement). It is thereby advantageously ensured that the viewing window is cleaned particularly well.

### BRIEF DESCRIPTION OF THE DRAWING FIGURES

An illustrative embodiment of the invention is explained in greater detail with reference to the appended drawings, in which:

FIG. 1: shows a schematic representation of an exemplary buttermaking apparatus according to the invention;

FIG. 2: shows a detail of the apparatus according to FIG. 1 in the region of an inspection glass on a vacuum chamber of a press of the apparatus,

FIG. 3: shows a front view of an inspection glass;

FIG. 4: shows a sectional view of the inspection glass according to FIG. 3;

FIG. 5: shows a further sectional view of the inspection glass according to FIG. 3.

### DETAILED DESCRIPTION

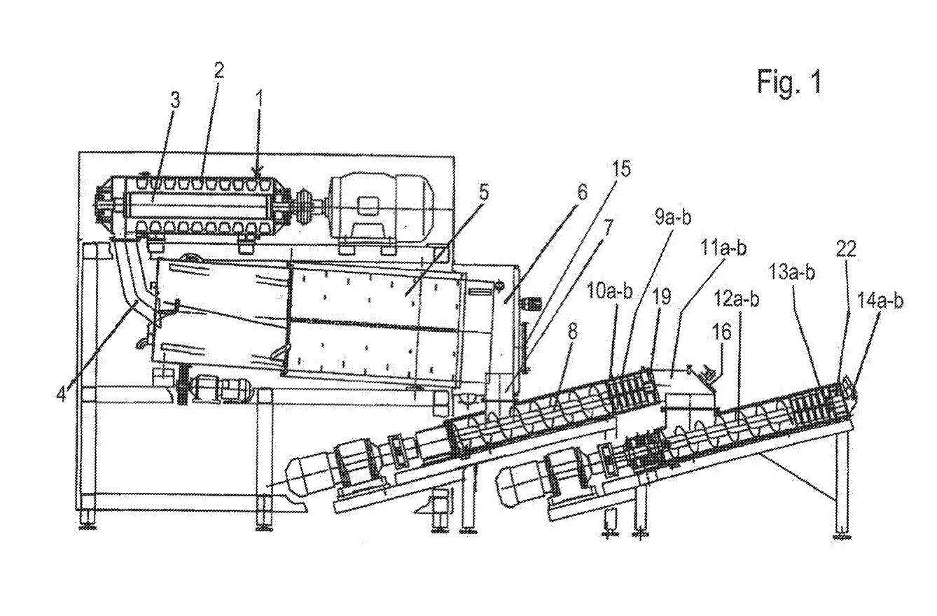

FIG. 1 shows a buttermaking apparatus, hereinafter referred to as a churning machine, which has an inlet 1 for cream, and a churning cylinder 2 having a rotatably driven beater 3 for the formation of butter grain and butter milk from supplied cream.

The apparatus also includes a cooling section 4 in which the butter grain acquires a harder consistency and can subsequently be better processed.

The apparatus further includes a secondary churning drum 5 used to set the optimal butter grain size in the secondary churning process.

The butter grain is subsequently transferred, via a hood 6 having a feed shaft 7, into a first pressing stage having a press 8.

The press 8 transforms the butter grain into a homogeneous “water-in-oil emulsion” and simultaneously rids the formed butter intermediate product of buttermilk residues, which are subsequently led off.

The press 8 can include, by way of example, two mixing sections 9a and 9b, in which respectively a partial mass of the butter intermediate product can be processed separately. Thus, various butter grades of the end product can be attained in continuous production.

In this example the mixing sections 9a or 9b each have at least one metering connection 10a or 10b in order to add additional flavoring substances, water or whey, acid concentrates and brine, to the butter intermediate product in predefined quantity.

The butter intermediate product subsequently makes its way from respectively a mixing section 9a or 9b, via a vacuum chamber 11a or 11b, in this case into a second press stage, consisting of two presses 12a, 12b. The two presses of the second stage are spatially separated, wherein respectively a press 12a or 12b processes a partial mass of the butter intermediate product of respectively a mixing section 9a or 9b.

Air is extracted from the respective partial mass of the butter intermediate product in the respective vacuum chamber 11a, 11b of the first press stage in order to increase the storage life thereof and in order to prevent layers from forming as a result of air entrapment. The vacuum chambers 11a, 11b respectively have a second inspection glass 16, through which the process in the vacuum chamber is observable.

The presses 12a, 12b of the second press stage ensure, together with the following mixing zones 13a, 13b, an even distribution of the water content and an optimization of the water content in the two partial masses of the butter intermediate product.

The butter end products leave the churning machine in this case via outlets, which in the present drawing are represented by two mouthpieces 14a and 14b and a discharge pump 22.

As is evident from FIG. 1, the hood 6 has a first inspection glass 15, through which the secondary churning process in the secondary churning drum 5 can be observed.

The first inspection glass 15 has a device with which a viewing window of the first inspection glass 15 is heatable (the latter not represented in this drawing). The heating device is constituted, for example, by heating conductors inserted in the viewing window of the first inspection glass and made of a material having a suitable electrical resistance, so that the viewing window is electrically heatable by the heating conductors. Alternatively, heating devices operating using a different working principle can also be employed.

As a result of the heating device, it is advantageously possible for butter deposits forming on the first inspection glass 15 by production in the churning machine to be removable, or for the first inspection glass 15 to be cleanable. To this end, the heating device of the viewing window of the first inspection glass 15 is switched on. As a consequence of the heat build-up, the butter deposits adhering to the viewing window of the first inspection glass 15 are melted, so that the butter deposits can drip down from the viewing window of the first inspection glass 15 into the ongoing churning process. As a result, the unrestricted observation of the secondary churning process in the secondary churning drum 5 is advantageously enabled.

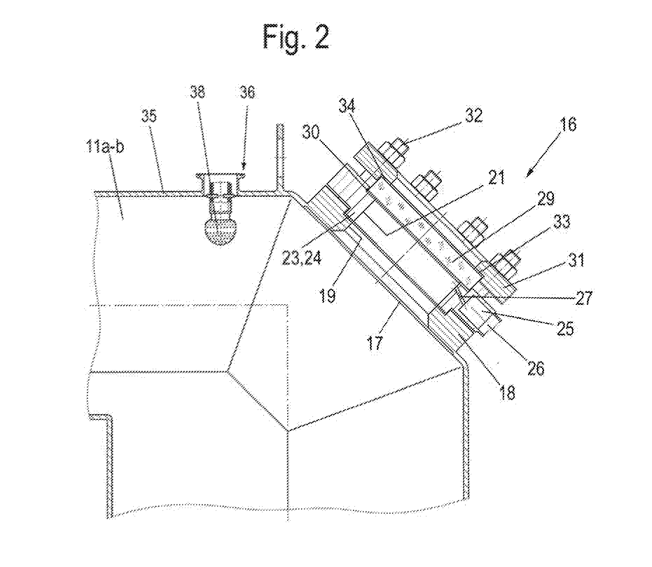

FIG. 2 illustrates a detail of the churning machine according to FIG. 1 in the region of a second inspection glass 16 on the vacuum chamber 11a or 11b of FIG. 1.

The second inspection glass 16 is described below and the structure of the first inspection glass 15 can be shaped analogously or identically to the structure of the second inspection glass 16.

The vacuum chamber 11a, 11b respectively has an opening 17. Congruent to the opening 17, the vacuum chamber 11a, 11b respectively has a flange 18, which is fastened to the vacuum chamber 11a, b.

The flange 18 likewise has an opening 19, which is designed contour-congruent to the opening 17 and is therefore arranged corresponding to the opening 17. An intermediate element 20, which likewise has an opening 21, is disposed on the flange 18. This opening 21 is also designed contour-congruent to the opening 17 and is therefore arranged corresponding to the opening 17.

Thus, a continuous opening of, in this case, constant cross-section is thereby obtained, which opening extends through the vacuum chamber 11a, or 11b, the flange 18 and the intermediate element 20 and respectively has the partial openings 17, 19, 21.

The intermediate element 20 has a centering lug 23, which engages in a geometrically corresponding recess 24 of the flange 18. A seal is arranged between the centering lug 23 and the recess 24 to seal off the openings 19, 21 from the environment.

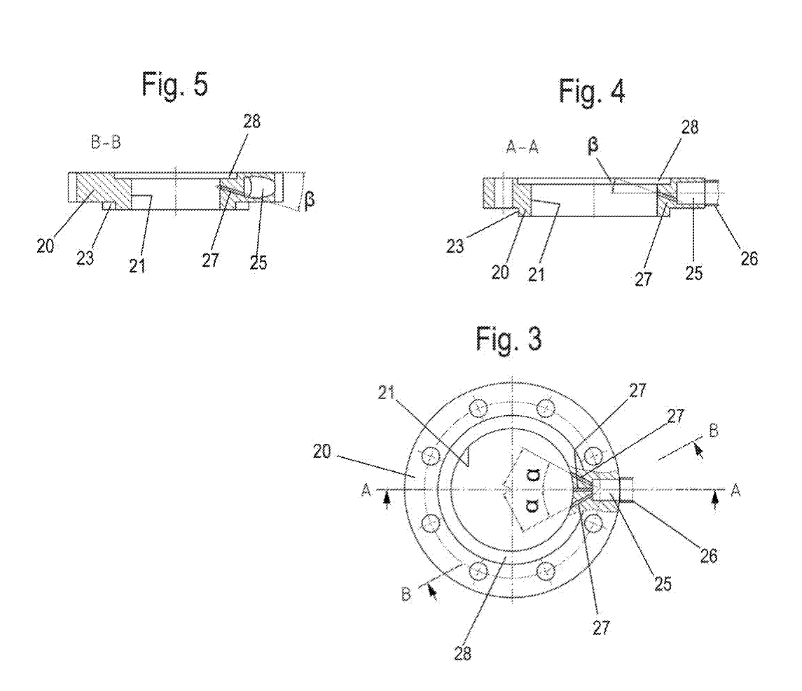

The intermediate element 20 of the second inspection glass 16 has a connection 25 for a line or a hose 26. In addition, the intermediate element 20 of the second inspection glass 16 has at least one 27 or more nozzle-like passages 27, which connects the connection 25 to the opening 21. The openings 21 of the, in this example, three passages 27 (see FIG. 3) are directed towards that side of the intermediate element 20 facing away from the vacuum chamber. As a result of the connection 25 and the nozzle-like passages 27, a fluid—for example steam—can be conducted through the intermediate element 20 into the opening 21.

The vacuum chamber 11a, 11b (see FIG. 2) has a wall 35, which is provided with a bushing 36. A nozzle arrangement 38 is inserted in the bushing 36. A vacuum pump (not represented here) can be connected to the bushing 36, outside of the vacuum chamber 11a, 11b, with which air, and, where appropriate, steam, can be sucked out of the vacuum chamber 11a, 11b.

The nozzle arrangement 38 is designed in the style of a multiple nozzle (“sprayball-like”), which has a plurality of small diameter fine intake openings within the vacuum chamber 11a, 11b, which open out into a common duct of larger diameter, which passes through the wall 35.

FIG. 3 and FIG. 4 respectively illustrate the intermediate element 20 having the nozzle-like passages 27. The, in this case, three nozzle-like passages 27 are arranged preferably at an angle β of 10 to 20°, particularly preferably 15°, perpendicular to the axis of the opening 21. The three passages are arranged in a parallel plane perpendicular to the axis of the opening 21, preferably at an angle a of 20 to 60°, particularly preferably of 30°, relative to one another in a fan-like arrangement. The nozzle-like passages 27 have a diameter preferably between 1 and 5 mm, particularly preferably of 1.5 mm.

The intermediate element 20 of the first inspection glass 15 can optionally likewise have a connection 25 and one or more nozzle-like passages 27, with which the viewing window 29 of the first inspection glass 15 can be subjected to a fluid. This is advantageous, but not essential.

The intermediate element 20 has a recess 28, in which the viewing window 29 is placed. A seal 30 is arranged between the viewing window 29 and the intermediate element 20 is arranged a seal 30 to seal off the opening 21 from the environment.

The viewing window 29, and thus the second inspection glass 16, has a device with which the viewing window 29 is heatable (not represented here). The heating device is in turn preferably constituted by heating conductors inserted in the viewing window 29 and made of a material having a suitable electrical resistance, so that the viewing window 29 of the second inspection glass 16 is electrically heatable by the heating conductors. Alternatively, heating devices operating with a different working principle can also be employed. As a result of the heating device, it is in turn advantageously possible to automatically remove or clean butter deposits forming on the viewing window 29 of the second inspection glass 16 during the buttermaking in the churning machine. To this end, the butter deposits adhering to the viewing window 29 of the second inspection glass 16 are in turn melted with the heating device, so that the butter deposits can drip down from the viewing window 29 of the second inspection glass 16. The temperature attainable at the inspection glass—in this case 16—in the course of the heating is preferably 40 to 90° C., more preferably 60° C. A temperature above 90° C. appears less advantageous because evaporation of the water in the butter is undesirable.

The viewing window 29 of the second inspection glass 16 is screwed and pressed with an inspection glass rest 31 onto the intermediate element 20 by a plurality of screws 32. To this end, the inspection glass rest 31 has a recess 33, in which the viewing window 29 engages. A seal 34 is arranged between the viewing window 29 and the inspection glass rest 31 to seal off the viewing window 29 from the environment.

Through the nozzle-like passages 27, the viewing window 29 of the second inspection glass 16 can additionally be subjected to a fluid, such as, for example, steam. As a result, butter deposits on the viewing window 29 that have been melted by the heating element are advantageously additionally rinsed off the viewing window 29.

Hence films on the viewing window that are formed in addition to the butter deposits and derive from butter additives, such as, for example, additional flavoring substances, water or whey, acid concentrates and brine, can advantageously also reliably be automatically cleaned off.

As a result of the heatability of the viewing window 29 of the second inspection glass 16 with the heating element and the additional possibility of being able to remove stubborn films of butter additives on the viewing window 29 of the second inspection glass 16 by subjecting the viewing window 29 to a fluid, such as, for example, steam, the unrestricted observation of the buttermaking is advantageously optimized.

Although the present invention has been described above by means of embodiments with reference to the enclosed drawings, it is understood that various changes and developments can be implemented without leaving the scope of the present invention, as it is defined in the enclosed claims.

### REFERENCE SYMBOLS

inlet 1

churning cylinder 2

beater 3

cooling section 4

secondary churning drum 5

hood 6

feed shaft 7

press 8

mixing section 9a, 9b

metering connection 10a, 10b

vacuum chamber 11a, 11b

press 12a, 12b

mixing zone 13a, 13b

mouthpiece 14a, 14b

inspection glass 15

inspection glass 16

opening 17

flange 18

opening 19

intermediate element 20

opening 21

discharge pump 22

centring lug 23

recess 24

connection 25

hose 26

passage 27

recess 28

viewing window 29

seal 30

inspection glass rest 31

screw 32

recess 33

seal 34

wall 35

bushing 36

nozzle arrangement 38

1. A buttermaking apparatus, comprising:
a. an inlet;
b. a churning cylinder coupled to the inlet and having a rotatable beater;
c. a secondary churning drum coupled to the churning cylinder having a hood;
d. a press stage coupled to the secondary churning drum; and
e. at least one inspection glass having a viewing window, wherein the viewing window has a heater.

2. The apparatus of claim 1, wherein the hood of the secondary churning drum has the viewing window with the heater.

3. The apparatus of claim 1, wherein the press stage has the viewing window.

4. The apparatus of claim 1, wherein the heater of the viewing window is an electrical heater.

5. The apparatus of claim 1, wherein the heater of the viewing window has one or more heating conductors.

6. The apparatus of claim 1, wherein the heater is configured to heat the viewing window to a temperature causing butter from cow's milk to melt.

7. The apparatus of claim 1, wherein the viewing window is arranged to be subjected to a fluid.

8. The apparatus of claim 7, wherein the fluid is steam.

9. The apparatus of claim 7, wherein the fluid is conducted through one or more nozzle-like passages onto the viewing window of the at least one inspection glass.

10. The apparatus of claim 9, further comprising:
an intermediate element having the one or more nozzle-like passages.

11. The apparatus of claim 10, wherein the viewing window is arranged in a recess of the intermediate element.

12. The apparatus of claim 11, wherein the intermediate element is arranged on a flange disposed on a vacuum chamber or the hood.

13. The apparatus of claim 10, wherein the viewing window engages in a recess of an inspection glass rest.

14. The apparatus of claim 13, wherein the viewing window is fastened to the intermediate element by means of the inspection glass rest and screws.

15. The apparatus of claim 10, wherein the one or more nozzle-like passages is/are arranged at an angle 10 to 20° perpendicular to an axis of an opening of the intermediate element.

16. The apparatus of claim 15, wherein the plurality of nozzle-like passages are arranged in a parallel plane perpendicular to the axis of the opening 21 and at an angle of 20 to 60° to one another in a fan-like arrangement.

17. The apparatus of claim 9, wherein the one or more nozzle-like passages has or have a diameter between 1 and 5 mm.
